(19) United States
(12) Patent Application Publication
(10) Pub. No.: US 2008/0270232 A1
(43) Pub. Date: Oct. 30, 2008

(54) Method and system for conveying a message

(76) Inventor: Paul Willms, Everett, WA (US)

Correspondence Address: WAGNER BLECHER LLP, 123 WESTRIDGE DRIVE, WATSONVILLE, CA, 95076, US

(21) Appl. No.: 11/789,522

(22) Filed: Apr. 25, 2007

(51) Int. Cl. G06Q 30/00; B60P 3/08

(52) U.S. Cl. 705/14; 410/26

(57) ABSTRACT

Embodiments of the present invention recite a method and system for conveying a message. In one embodiment in accordance with the present invention, access to an intermodal shipping container is obtained. A message to be conveyed upon the intermodal shipping container is then obtained. The intermodal shipping container is then used to convey the message.

### TECHNICAL FIELD

Embodiments in accordance with the present invention generally pertain to message delivery.

### BACKGROUND

Demand for message delivery is increasing worldwide. The growth of outdoor message delivery is being driven in part by the emergence of new technologies and increasing globalization. Currently one type of message delivery, outdoor advertising, is the second fastest growing advertising segment after the Internet with growth rates between 8% and 12% depending upon the region.

Because of the popularity of outdoor message delivery, new mediums for conveying the delivery of messages are constantly in demand. Additionally, due to the increase in demand for outdoor message delivery, the costs of outdoor message delivery will continue to increase unless new mediums for conveying a message are found.

### SUMMARY OF THE INVENTION

Embodiments of the present invention recite a method and system for conveying a message. In one embodiment in accordance with the present invention, access to an intermodal shipping container is obtained. A message to be conveyed upon the intermodal shipping container is then obtained. The intermodal shipping container is then used to convey the message.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows an exemplary intermodal shipping container upon which embodiments of the present invention may be implemented.

FIG. 2 shows an exemplary message delivery medium in accordance with embodiments of the present invention.

FIG. 3 shows an exemplary intermodal shipping container with a message conveyed thereon in accordance with embodiments of the present invention.

FIG. 4 shows an exemplary message delivery system in accordance with embodiments of the present invention.

FIG. 5 is a flowchart of a method for conveying a message in accordance with embodiments of the present invention.

FIG. 6 is a flowchart of a method for conveying a message in accordance with embodiments of the present invention.

### DETAILED DESCRIPTION OF THE INVENTION

In the following detailed description of the present invention, numerous specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

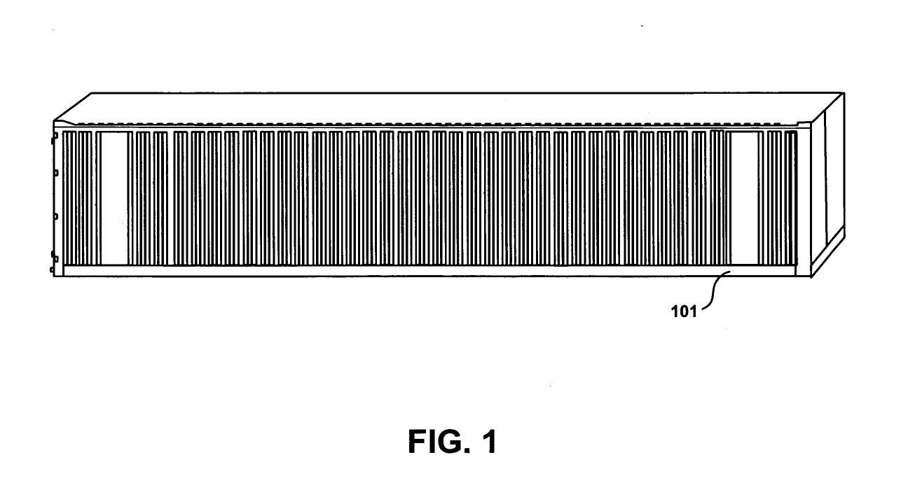

FIG. 1 shows an exemplary intermodal shipping container 100 upon which embodiments of the present invention may be implemented. The term intermodal refers to utilizing more than one mode of transportation to move freight from a point of origin to a destination. In addition, it is understood that the freight itself is not handled when switching between transportation modes. Typically, this involves using standardized shipping containers which can be easily transferred from one mode of transportation (e.g., a container ship, or train) to another mode of transportation (e.g., a truck). The standardized intermodal shipping container has facilitated a huge reduction in handling costs for ports and shipping companies which has in turn contributed to lower freight charges and faster transfer of the freight between transportation modes. Additional benefits of using intermodal shipping containers include increased security of the freight itself, and reduced damage and loss of the freight. By some estimates, up to 90% of worldwide non-bulk cargo is transported in standard intermodal shipping containers. While there are a variety of standard lengths for intermodal shipping containers (e.g., 20 foot, 40 foot, 45 foot, 48 foot, and 53 foot lengths), the standard intermodal containers used in the United States are typically the 48 foot and 53 foot containers.

As shown in FIG. 100, intermodal shipping container 100 comprises a standard 48 foot intermodal cargo shipping container having a lower rail 101 upon which the side walls of intermodal shipping container 100 are built. It is noted that while not shown in FIG. 1, some intermodal shipping containers also have an upper rail which is similar to lower rail 101 of FIG. 1. As shown in FIG. 1, the dimensions of lower rail 101 are an approximate length of 48 feet and an approximate width of 5.9 inches. It is noted that the width of the lower rails of standard intermodal shipping containers of other lengths is also approximately 5.9 inches. In embodiments of the present invention, lower rail 101 and/or the upper rail of intermodal shipping container 100 provides a space upon which messages may be placed. As intermodal shipping container 100 is transported from place to place, it will convey the message. In one embodiment in accordance with embodiments of the present invention, the message disposed upon intermodal shipping container 100 may be selected based upon a specific targeted populated geographic region. In other words, knowing the point of origination and/or the destination of shipping container 100, a message a message can be selected which is appropriate for the targeted populated geographic region. Embodiments of the present invention comprise using an intermodal shipping container, and/or a transporter of the intermodal shipping container as a medium for conveying a message.

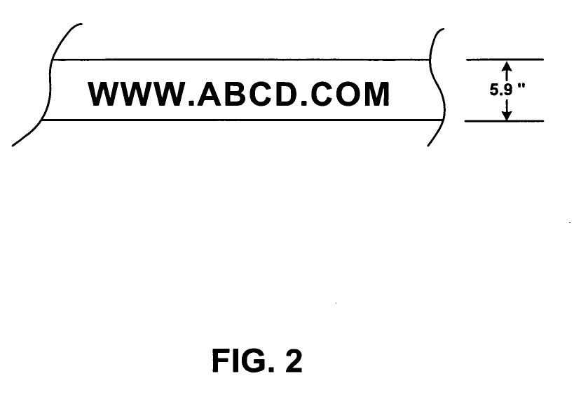

FIG. 2 shows an exemplary advertising medium 200 in accordance with one embodiment of the present invention. In the embodiment of FIG. 2, advertising medium 200 comprises an adhesive tape upon which a selected message may be disposed. In embodiments of the present invention, advertising medium 200 is configured to be disposed upon lower rail 101 of intermodal shipping container 100. It is noted that in an embodiment in accordance with the present invention, advertising medium 200 may also be disposed upon other parts of intermodal shipping container 100 such as the sides, rear, and top rail of intermodal shipping container 100 if one is present. Additionally, advertising medium 200 may be disposed upon the transporter of intermodal shipping container 100. For example, when intermodal shipping containers are transported by road, they are loaded onto a trailer which is pulled by a truck. Typically, the trailer consists of a rail or beam which is attached to a set of wheels. Alternatively, the intermodal shipping container can be loaded onto a flatbed trailer. In an embodiment in accordance with the present invention, advertising medium 200 may be disposed upon the rail or beam of the trailer, or onto a portion of the flatbed trailer.

In an embodiment in accordance with the present invention, the width of advertising medium 200 does not exceed 5.9 inches. However, in another embodiment, advertising medium 200 may exceed 5.9 inches if so desired. In embodiments in accordance with the present invention, advertising medium 200 is not necessarily limited to a given length. In other words, it may be printed as an essentially continuous roll of tape in which the selected message printed upon adverting medium 200 is repeated. To implement a roll of advertising medium 200, a desired length is measured and cut from, for example, a spool of tape upon which is printed the selected message.

In one embodiment in accordance with the present invention, the back side of advertising medium 200 is at least partially coated with an adhesive to facilitate adhesively coupling advertising medium 200 with lower rail 101 of intermodal shipping container 100. It is noted that in another embodiment, another method for coupling advertising medium with lower rail 101 may be utilized such as a hook and pile fastener (e.g., Velcro®), or a fastener or a more permanent nature. The use of an adhesive allows disposing message delivery medium 200 upon lower rail 101 quickly. However, when a more permanent solution is desired for coupling message delivery medium 200 with lower rail 101, one of the above mentioned methods may be used.

In another embodiment in accordance with the present invention, a selected message may be painted onto lower rail 101 of intermodal shipping container 100. For example, in an embodiment in accordance with the present invention, rather than being a printed medium, message delivery medium 200 comprises a paining template or stencil which can be disposed over, for example, lower rail 101. The selected message can then be spray painted directly onto lower rail 101 of intermodal shipping container 100, or a transporter thereof. In one embodiment in accordance with the present invention, the lettering of message delivery medium 200 may be reversed such that it is readable to a person viewing message delivery medium via the rear-view mirror of an automobile.

In embodiments in accordance with the present invention, message delivery medium 200 comprises a weather-resistant medium such as a plastic or weather-resistant paper product. In one embodiment, message delivery medium 200 is to be used as a temporary medium for conveying a message. Thus, it is advantageous to use a less durable medium, such as a paper product, in one embodiment. In another embodiment, it may be desirable to use a more durable, or permanent, medium for message delivery medium 200 such as a plastic product or a painted message. In one embodiment of the present invention, message delivery medium 200 comprises a printable medium. For example, a selected message may be printed upon message delivery medium 200 using ink, paint, or the like. In another embodiment, the selected message and/or the background of message delivery medium 200 comprises a reflective material which enhances the selected message and/or background of message delivery medium 200 when a light is shined upon it.

Embodiments of the present invention facilitate a low-cost medium for presenting a selected message. For example, message delivery medium 200 can be typically be printed as a roll of adhesive tape (e.g., message delivery medium 200) at a lower cost than is required to print a sign. The lower cost of creating the tape means that message delivery space can be made available at a lower cost than other message delivery media. Also, because one embodiment in accordance with the present invention utilizes an adhesive backing to couple message delivery medium 200 with intermodal shipping container 100, the selected message can be applied and changed quickly without a significant expenditure. Additionally, the lower cost of creating and applying message delivery medium 200 means that the selected message can be changed quickly in response to current events so that the message conveyed is more relevant to current conditions.

An additional advantage of the present invention is the widespread use of standardized intermodal shipping containers for moving cargo. As a result, a selected message can quickly cover a region by attaching message delivery medium 200 to intermodal shipping containers entering the region. For example, message delivery medium 200 can be quickly attached to intermodal shipping containers at their port of debarkation. Because the intended destination of a given intermodal shipping container can easily be determined at the port of debarkation, a message selected for a given targeted populated geographic region can be quickly attached to the intermodal shipping container.

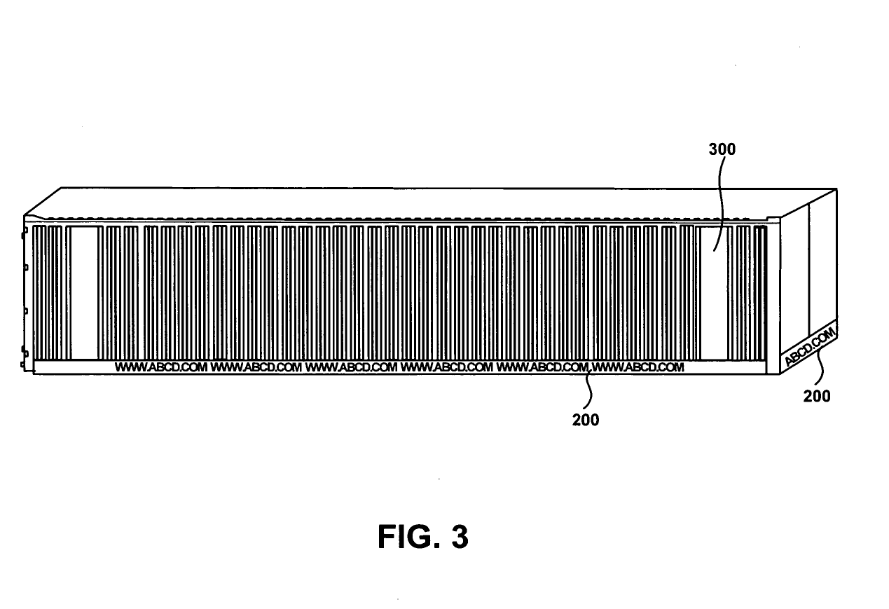

FIG. 3 shows an exemplary intermodal shipping container 300 with an exemplary message attached in accordance with embodiments of the present invention. As shown in FIG. 3, intermodal shipping container 300 has a message disposed upon its lower rail. In the embodiment of FIG. 3, message delivery medium 200 conveys the name of a fictional website, WWW.ABCD.COM. As shown in FIG. 3, the addition of message delivery medium 200 to the lower rail of intermodal shipping container 300 does not prevent the use of other markings on the lower rail of the intermodal shipping container if they are necessary. For example, loading data, attachment points, etc. can be marked upon the lower rail while still permitting the display of a selected message via message delivery medium 200. Displaying additional messages on the sides or rear of intermodal shipping container 300 is also possible without being impeded by message delivery medium 200.

As shown in FIG. 3, message delivery medium 200 displays a first message 301 on one side of intermodal shipping container 300 and a second message 302 on the rear of intermodal shipping container 300. Embodiments in accordance with the present invention facilitate displaying at least one message upon at least one side of an intermodal shipping container 300 and/or a transporter thereof. For example, each side of intermodal shipping container 300 may display a different message, or the same message on all sides. Alternatively, a selected message may be displayed upon only one side while one or more messages are displayed upon other sides, or the same side, of intermodal shipping container 300.

Embodiments in accordance with the present invention leverage the widespread use of intermodal shipping containers to move products. It is estimated that 17 million intermodal shipping containers log nearly 3 trillion miles of movement yearly. Thus, there is a huge potential for using otherwise unused space to present a selected message. As a result, a potentially important source of revenue may be created using embodiments of the present invention.

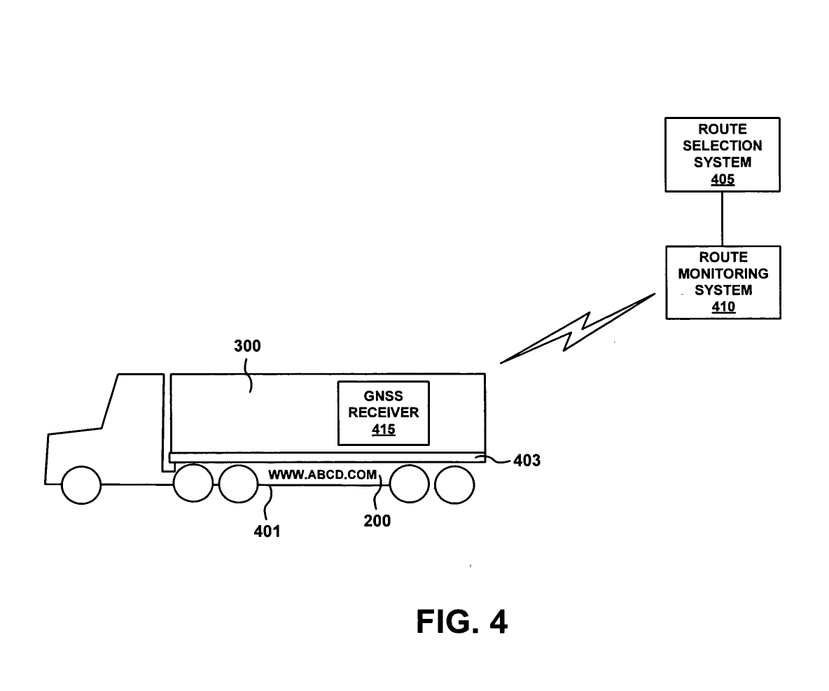

FIG. 4 shows an exemplary message delivery system 400 in accordance with embodiments of the present invention. In FIG. 4, a message delivery medium 200 is coupled with a rail 401 of a trailer carrying intermodal shipping container 300. It is noted that a second message delivery medium 200 (not shown) may be coupled with rail 403 of intermodal shipping container 300 in addition to, or instead of the message delivery medium which is coupled with rail 401 in accordance with embodiments of the present invention. Also shown in FIG. 4 is a route selection system 405 which is communicatively coupled with a route monitoring system 410. It is noted that in one embodiment in accordance with the present invention, route selection system 405 is not communicatively coupled with route monitoring system 410.

In embodiments in accordance with the present invention, route selection system 405 is for selecting a route for intermodal shipping container 300. In one embodiment in accordance with the present invention, route selection system 405 may be operated by an advertising agency, an owner of intermodal shipping container 300, an owner of the cargo transported by intermodal shipping container 300, the advertiser using message delivery medium 200, etc. In one embodiment in accordance with the present invention, route selection system 300 utilizes information such as the demographics of a targeted populated geographic region, traffic patterns in a targeted populated geographic region, as well as local conditions such as weather, current events, or local variations of the previously mentioned variables. In one embodiment in accordance with the present invention, an algorithm used by route selection system 405 may be used to estimate the revenue stream originated caused by exposure to the selected message. Using route selection system 405, a route for intermodal shipping container 300 can be planned which will convey the message displayed by message delivery medium 200 to a wider population, or to a selected sub-group within a targeted populated geographic region. It is noted that while the present embodiment mentions directing a selected message at a specific population or targeted region, embodiments in accordance with the present invention are not limited to specifically targeted messages alone. For example, message delivery medium can convey information of a more general nature such as a website address, or public service announcement.

In embodiments in accordance with the present invention, route monitoring system 410 is for monitoring the route followed by intermodal shipping container 300. In embodiments in accordance with the present invention, this may comprise utilizing Global Navigation Satellite System (GNSS) compliant devices which are used to report the geographic position of intermodal shipping container 300 at a given time. Current technological trends increasingly rely upon geographic reporting devices to track the location of equipment, vehicles, and property to assist in theft recovery, monitor resource allocation, or to monitor productivity. In embodiments in accordance with the present invention, a GNSS receiver 415 is disposed with intermodal shipping container 300 and is used to track its geographic position. In one embodiment in accordance with the present invention, the GNSS receiver 415 may be incorporated into a security device such as a lock used for theft prevention. In another embodiment in accordance with the present invention, GNSS receiver 415 is a built-in component of intermodal shipping container 300. In another embodiment in accordance with the present invention, GNSS receiver 415 may be a discreet position recording and/or reporting device which is attached to, or disposed within intermodal shipping container 300. In one embodiment in accordance with the present invention, the geographic position information can be sent in real-time to route monitoring system 410 using a wireless communication pathway. Using this information, route monitoring system 410 can provide information which is used by advertisers to determine when and where their selected message is being presented to a targeted populated geographic region. Thus, embodiments in accordance with the present invention provide accountability and metrics to facilitate determining whether a selected message is being presented in a desired manner.

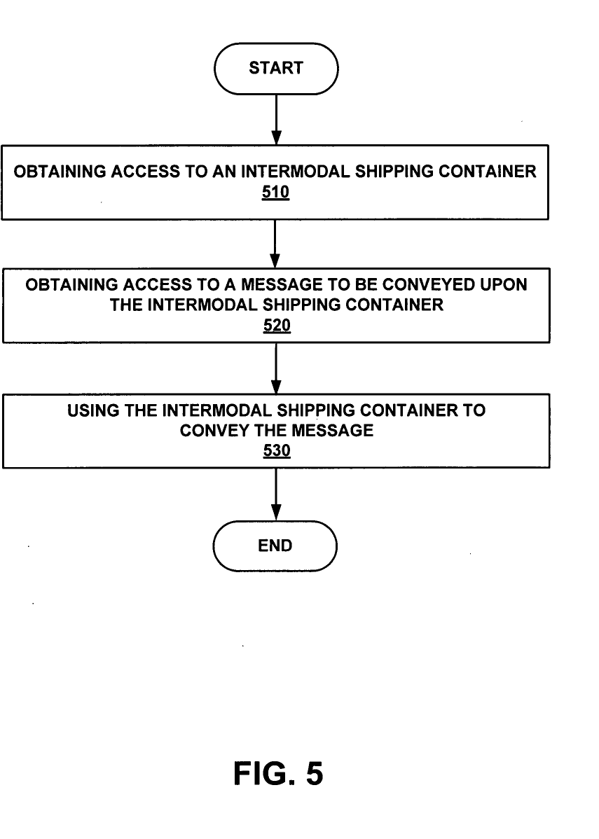

FIG. 5 is a flowchart of a method 500 for conveying a message in accordance with embodiments of the present invention. In step 510 of FIG. 5, access to an intermodal shipping container is obtained.

In step 520 of FIG. 5, a message to be conveyed upon the intermodal shipping container is obtained.

In step 530 of FIG. 5, the intermodal shipping container is used to convey the message.

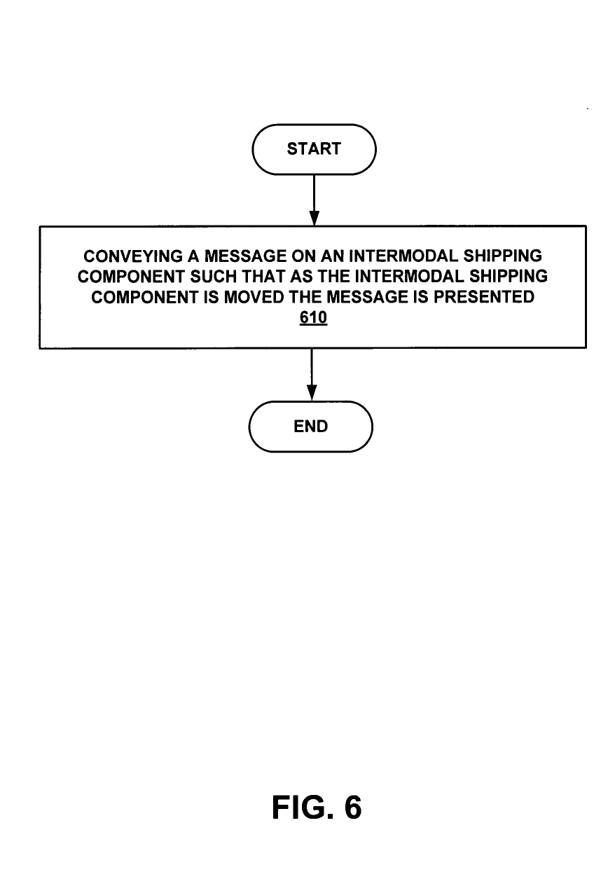

FIG. 6 is a flowchart of a method 600 for conveying a message in accordance with embodiments of the present invention. In step 610 of FIG. 6, a message is conveyed on an intermodal shipping component such that as the intermodal shipping component is moved the message is presented

Embodiments of the present invention, a method and system for conveying a message, are thus described. While the present invention has been described in particular embodiments, it should be appreciated that the present invention should not be construed as limited by such embodiments, but rather construed according to the below claims.

What is claimed is:

1. A method for conveying a message, said method comprising:
obtaining access to an intermodal shipping container;
obtaining a message to be conveyed upon said intermodal shipping container; and
utilizing said intermodal shipping container to convey said message.

2. The method as recited in claim 1 further comprising:
utilizing a message delivery medium which does not exceed 5.9 inches in width.

3. The method as recited in claim 2 wherein said conveying further comprises:
selecting said message delivery medium from a group consisting of: a printable adhesive medium, a painted message delivery medium, and a reflective adhesive medium.

4. The method as recited in claim 1 further comprising:
selecting a route for said intermodal shipping container for presenting said message.

5. The method as recited in claim 1 further comprising:
monitoring the route followed by said intermodal shipping container.

6. The method as recited in claim 1 further comprising:
selecting said message based upon a targeted populated geographic region.

7. The method as recited in claim 1 further comprising:
obtaining access to a transporter of said intermodal shipping container; and
utilizing said transporter to convey said message.

8. A message delivery medium comprising:
an intermodal shipping component; and
a selected message disposed upon said intermodal shipping component.

9. The message delivery medium of claim 8 wherein said selected message is selected based upon a targeted populated geographic region.

10. The message delivery medium of claim 9 wherein said message is selected based upon a route to be followed by said intermodal shipping container through said targeted populated geographic region.

11. The message delivery medium claim 8 wherein said message delivery medium does not exceed 5.9 inches in width.

12. The message delivery medium of claim 8 wherein said message delivery medium is selected from the group consisting of: a printable adhesive surface, a painted message delivery medium, and a reflective adhesive surface.

13. A method for conveying a message, said method comprising:
conveying a message on an intermodal shipping component such that as said intermodal shipping component is moved said message is presented.

14. The method as recited in claim 13 further comprising:
utilizing a message delivery medium which does not exceed 5.9 inches in width to display said message on said intermodal shipping component.

15. The method as recited in claim 14 further comprising:
selecting said message delivery medium from the group consisting of: a printable adhesive surface, a painted message delivery medium, and a reflective adhesive surface.

16. The method as recited in claim 13 further comprising:
selecting a route for said intermodal shipping component.

17. The method as recited in claim 13 further comprising:
monitoring the route of said intermodal shipping component.

18. A message delivery system comprising:
a intermodal shipping component; and
a selected message disposed upon said intermodal shipping component.

19. The message delivery system of claim 18 further comprising:
a message delivery medium disposed upon said intermodal shipping component and wherein said message delivery medium does not exceed 5.9 inches in width.

20. The message delivery system of claim 19 wherein said message delivery medium is selected from a group consisting of: a printable adhesive tape, a painted message delivery medium, and a reflective adhesive tape.

21. The message delivery system of claim 18 further comprising:
a route monitoring system for monitoring the route followed by said intermodal shipping container.

22. The message delivery system of claim 18 further comprising:
a route selection system for selecting a route for said intermodal shipping container.
